(19) United States
(12) Patent Application Publication
(10) Pub. No.: US 2010/0230366 A1
(43) Pub. Date: Sep. 16, 2010

(54) SEAWATER TREATMENT METHOD FOR THE PRODUCTION OF INJECTION WATER FOR UNDERSEA OIL DRILLING AND CORRESPONDING INSTALLATION

(75) Inventors: Didier Bigeonneau, Saint Leger en Yvelines (FR); Renaud Sublet, Maisons-Laffite (FR); Herve Suty, Nogent-Sur-Marne (FR); Wayne Ewans, Pershore-Worcestershire (GB)

Correspondence Address: COATS & BENNETT, PLLC, 1400 Crescent Green, Suite 300, Cary, NC, 27518, US

(73) Assignee: OTV SA, Saint-Maurice Cedex (FR)

(21) Appl. No.: 12/305,305

(22) PCT Filed: Sep. 25, 2008
(86) PCT No.: PCT/EP08/62865

§ 371 Date: Jun. 12, 2009

(51) Int. Cl. C02F 1/20; B01D 19/00; B01D 63/00; C02F 1/70

(52) U.S. Cl. 210/750; 95/46; 96/6; 210/198.1

(57) ABSTRACT

A method for decreasing the dissolved oxygen content in water used for extracting oil from rocks includes directing water and gas into a housing containing at least one hydrophobic membrane such that the water contacts only a first surface of the membrane and the gas contacts only a second surface of the membrane. The pressure of the gas is decreased thereby causing the oxygen in the water to pass through the first side of the membrane to the second side of the membrane and mix with the gas. A system for decreasing the dissolved oxygen content in water used for extracting oil from rocks includes a plurality of membrane modules. Each module contains at least one hydrophobic membrane. A water supply inlet and a gas supply inlet direct water over the first and second surface respectively of each of the hydrophobic membranes. A water outlet and a gas outlet direct water and gas respectively out of the plurality of membrane modules.

### FIELD OF THE INVENTION

The field of the invention is that of seawater treatment.

More specifically, the invention relates to the treatment of seawater within the scope of oil drilling water production particularly on offshore platforms or constructions.

### PRIOR ART AND DRAWBACKS OF THE PRIOR ART

Oil is contained in more or less porous and permeable rocks.

The oil extraction process includes two main phases: a so-called primary production phase and a so-called secondary production phase.

The primary production phase consists in extracting the oil trapped in these rocks (or reservoirs) under the only effect of the pressure applied.

The secondary production phase consists in continuing the extraction of the oil contained in these rocks by injecting water, which is frequently referred to as injection or pressure maintenance water, therein.

In offshore operations, pipes are used to carry the injection water, and transport the hydrocarbons extracted from the undersea wellheads to the offshore production platforms.

The injection water, produced from seawater, must have a certain level of quality. The quality criteria such as salt content, turbidity, etc., include the dissolved oxygen (O₂) concentration. In fact, the injection water must necessarily be deoxygenated in order to limit the corrosion of these pipes.

Three main types of deoxygenation method have thus been developed and are frequently used in offshore oil platforms:
methods using vacuum degassing towers,
methods using stripping towers particularly by means of petroleum gas,
the MINOX™ catalytic method.

The methods using vacuum degassing towers are based on Henry's law whereby the solubility of a gas dissolved in a liquid is directly proportional to the partial pressure of this gas in the vapour in contact with the surface of the liquid.

Lowering the total pressure of a vapour phase in contact with a liquid phase by creating a vacuum thus makes it possible to decrease the solubility of a gas dissolved in the liquid, said gas being partially transferred in the vapour phase to a solubility threshold level imposed by the vacuum level and the efficiency of the method.

This pressure differential, referred to as the moving force, is used in degassing towers.

Deoxygenation in degassing towers consists in injecting the water to be treated at the top of the tower, within which vacuum, has been created, via devices which disperse the water into fine droplets which run down a lining developing a large contact area in order to facilitate the degassing of the oxygen. The gases extracted, particularly oxygen, but also the other gases dissolved in water (nitrogen, carbon dioxide, hydrogen sulphide, triohalomethanes, water vapour, etc.) are entrained into the vacuum circuit while the deoxygenated water is collected at the base of the tower.

The stripping methods are similar methods used in vertical towers, similar to vacuum towers, except that the total pressure inside the column is not lowered.

A scavenging gas is introduced from the bottom of the column and circulates against the flow (upwards) of the water running on the lining, and is extracted at the column head. The scavenging gas used may be of any type, provided that it contains a very low oxygen concentration, so as to create a moving force, corresponding to a partial pressure differential, which will favour the transfer of oxygen from the water to the gas. It must also be as chemically inert as possible with respect to water and avoid giving water corrosive properties. For example, it must contain the lowest possible amount of carbon dioxide (CO₂) which, once dissolved in water, may increase its acidity and, as a result, its corrosive potential.

These types of methods display drawbacks.

The passage of water in the distribution devices as well as the degassing or stripping phenomenon are accompanied by the formation of gas bubbles or foam which reduce the performances of the deoxygenation process. Therefore, in order to prevent foam formation, it is necessary to use anti-foaming chemical products.

An alternative to the use of such products consists in reducing the specific liquid flow rate. However, this results in an increase in the size of the installation so as to be able to treat the same volume of water.

Moreover, these physical methods display efficiency limits. Thus, in practice, degassing towers make it possible to obtain treated seawater oxygen contents between 50 and 100 ppb, which is insufficient. To achieve the desired treated seawater oxygen content lowering level, in practice approximately 20 ppb preferentially less than 10 ppb, it would be suitable to use large installations, for example, by assembling several lining stages in series. However, such a solution may not be reasonably envisaged in that it would result in the use of excessively costly and excessively bulky installations.

However, a lowering level of the oxygen contained in the seawater less than 20 ppb may be achieved using such degassing towers using chemical reducing or purifying agents (such as sodium bisulphite). These chemical products are added on top of the water contained at the base of such towers.

However, the use of such chemical products may raise logistic problems due to the problems that may be encountered for the routing thereof to offshore platforms and the storage and limited shelf-life thereof.

Besides the drawbacks described above, the use of degassing or stripping towers also raises installation constraints due to the problems with respect to platform or construction stabilisation. In addition, the significant weight/surface area ratio thereof results in the oversizing of some parts of metal platform structures.

The use of degassing or stripping towers also has the drawback of lacking flexibility due to the fact that the design thereof cannot be adapted easily to variations in the quality of the seawater to be treated.

A further drawback of these degassing or stripping towers relies on the fact that the performances thereof are affected by hydrodynamic variations. This is conveyed by the fact that the degassing or stripping towers may be difficult to stabilise in the case of variations in the water flow rate to be treated. Moreover, the ratio of the gas flow rate over the water flow rate must be observed, failing which:
if the gas flow rate becomes too high with respect to the water flow rate, the water flow may be affected or cease, which is known as flooding;
if the water flow rate becomes too high with respect to the gas flow rate, the gas flow may be affected, with a backmix thereof resulting in the gas stream.

Another drawback of the use of such degassing or stripping towers is associated with the fact that the water at the outlet thereof is not pressurised, which requires the use of recovery pumps to repressurise the water in the network.

In the MINOX™ catalytic method, which is described in the patent application under the number CA-A-1 222 200, the moving force is not a pressure differential but a concentration differential. In fact, it consists in lowering the partial pressure of the oxygen contained in the vapour phase in contact with the liquid, by replacing it by a gas practically free from oxygen, such as nitrogen.

Therefore, this method consists in mixing nitrogen intimately with seawater in static mixers in series, at the outlet whereof the oxygen-enriched gaseous atmosphere is treated in a catalytic combustion unit, which consumes the oxygen and thus regenerates the nitrogen consumed.

This type of method requires the use of installations offering the advantage of being less bulky than degassing towers. However, the weight thereof remains high.

Moreover, the use of this method requires, most of the time, the use of chemical products (anti-foaming agent, oxygen fixing agent, methanol for combustion) with all the drawbacks entailed particularly in logistic terms.

The problem of lack of flexibility or lack of modularity inherent to the use of degassing or stripping towers is significant with the use of static mixers in this MINOX™ catalytic method.

Another drawback of the MINOX™ catalytic method lies in the fact that a significant start-up time is required in cold temperature conditions.

The MINOX™ catalytic method displays a further drawback in that gaseous nitrogen may be entrained in deoxygenated water, which is liable to damage water pumping equipment.

### AIMS OF THE INVENTION

The aim of the invention is particularly to remedy the drawbacks of the prior art.

More specifically, an aim of the invention, in at least one embodiment, is to provide such a seawater treatment technique, which use enables the production of undersea drilling injection water with a low dissolved oxygen content.

Another aim of the invention is to use, in at least one embodiment, such a seawater treatment technique which can be used easily on an offshore platform.

Another aim of the invention is also to provide, in at least one embodiment, such a seawater treatment technique, which use requires installations of a reduced size and weight compared to the techniques of the prior art.

In addition, the invention aims to propose, in at least one embodiment, such a seawater treatment technique, which use limits logistic constraints.

In this way, the aim of the invention is particularly to provide, in at least one embodiment, such a seawater treatment technique, which use prevents foam formation.

Another aim of the invention, in at least one embodiment, is the provision of such a seawater treatment technique which is flexible and modular, i.e. which can evolve relatively easily particularly in terms of treatment capacities.

### DESCRIPTION OF THE INVENTION

These aims, along with others emerging hereinafter, are achieved using a seawater treatment method in an installation intended to be onboard an offshore platform or construction for the production of undersea oil drilling water depleted in oxygen initially dissolved in said seawater.

According to the invention, such a method comprises a deoxygenation step of said seawater, said deoxygenation step comprising:
a circulation step of said seawater via at least one battery incorporating a plurality of membrane modules assembled in series and each housing at least one porous and hydrophobic membrane;
a circulation step against the flow or through the flow of said seawater and independently via each of said membrane modules of a chemically inert scavenging gas having a dissolved oxygen concentration less than or equal to 5% molar;
an oxygen diffusion step from the oxygen-enriched seawater to the scavenging gas, the oxygen flowing through the water and gas separating membranes,

said seawater and said scavenging gas each circulating on a different side of said membrane.

In this way, the present technique is based on a completely novel approach to injection water production from seawater, which particularly consists in obtaining the degassing of seawater, i.e. lowering the oxygen content significantly, by circulating it via at least one battery incorporating hydrophobic membrane contactors assembled in series, wherein a scavenging gas, wherein the oxygen content is less than or equal to 5% molar, circulates independently and against the flow. In one alternative embodiment, it may be envisaged that the scavenging gas to flow through the water flow.

It is noted that the porous and hydrophobic membranes used in membrane modules (also referred to as “membrane contactors”) may be organic membranes or mineral membranes rendered hydrophobic by a specific treatment known in the prior art.

The use of such membrane contactors, which had previously never been envisaged for producing injection water, is remarkable particularly in that it makes it possible to:
lower the oxygen content significantly to values less than 20 ppb or even less than 10 ppb, without necessarily using oxygen-reducing chemical agents, where the techniques according to the prior art make it possible to lower the oxygen content to values between 50 and 100 ppb, which does not meet operators' expectations,
in installations wherein the weight/surface area ratio is relatively low compared to the techniques according to the prior art;
and to deoxygenate the water without using chemical products in that it prevents foam formation, and limit logistic constraints accordingly.

It is noted that the unit ppb refers to “part per billion”. It consists of micrograms per litre generally referred to by those skilled in the art as ppb.

The use of hydrophobic membranes makes it possible to prevent the liquid to be treated from coming into contact with the gas, unlike in the techniques according to prior art which require, by their nature, intimate contact between the water and the gas. This results in the prevention of foam formation in the liquid.

Moreover, the fact that the seawater and scavenging gas circulate at counter-current at either side of said membrane and independently in each of said membrane contactors helps favour the transfer of oxygen dissolved in the seawater to the gas phase.

The water treatment method according to the invention preferentially comprises at least one injection step of at least one reducing agent between two consecutive membrane modules.

The injection of reducing agent is of particular interest in that it may make it possible to achieve very low dissolved oxygen concentrations.

According to a preferred characteristic of the invention, said scavenging gas is nitrogen wherein the purity is greater than 95% molar.

According to one alternative embodiment, said scavenging gas is nitrogen wherein the purity is greater than or equal to 99.9%.

In fact, it was observed by the Applicant that the use of such gases in such proportions may lead to the production of a treated water wherein the oxygen content may be lowered significantly until values less than 30 ppb and preferentially less than 10 ppb.

In one advantageous embodiment, a seawater treatment method according to the invention comprises a production step of said nitrogen by means of an ambient air element separation method, said production step being conducted on said offshore platform or construction.

The use of such a nitrogen production step may advantageously be carried out by means of a dedicated unit which may be easily placed onboard an offshore platform. The production of nitrogen directly on the platform results in a reduction in logistic constraints and reduces the space requirements of an installation required to use the method according to the invention in that it is no longer necessary to provide the routing of nitrogen to the offshore platform or to provide large storage tanks.

In one alternative embodiment, said scavenging gas is a petroleum gas containing at least 50% molar of methane.

In another alternative embodiment, said scavenging gas is a petroleum gas containing between 5% molar and 30% molar of CO₂.

This embodiment offers the advantage of reusing a by-product found on the offshore platform so as to produce the scavenging gas which results in the limitation of the logistic constraints and reduction of operating costs (it is not necessary to purchase scavenging gas and have it routed to the offshore platform from the mainland).

This embodiment advantageously enables the use of a petroleum gas having a high carbon dioxide concentration (>5% molar) without reducing the quality of the water treated by the dissolution of carbon dioxide in water.

Advantageously, the pressure of said scavenging gas is between 20 and 250 mmHg (i.e. between 2666 and 33,320 Pa).

Such a scavenging gas pressure value range may result in the production of a treated water wherein the O₂ content is less than 30 ppb and preferentially less than 10 ppb.

According to an advantageous characteristic of the invention, the contact time of said seawater in each of said membrane modules is between 1 and 5 seconds.

Such a contact time of the water in each of the contactors results in an acceptable lowering of the dissolved oxygen, i.e. the production of a treated water wherein the O₂ content is less than 30 ppb and preferentially less than 10 ppb.

Advantageously, said circulation steps are preceded by a media filtration step and/or a microfiltration step and/or an ultrafiltration step. In this way, it is possible to prevent the obstruction of the membranes by the suspended matter.

Preferentially, said circulation steps are preceded or followed by a desalination step and/or a deionisation step.

The use of such a desalination and/or deionisation step makes it possible to lower the salinity and/or concentration in some ion species of the treated seawater. This may result, when the desalination and/or deionisation are used before the passage of the water through the membrane contactors, in preventing the obstruction of the membranes by precipitation of the salt and/or ions. However, when a desalination step is used before the circulation steps, the performances of the process according to the invention may be reduced in terms of degassing.

The invention also relates to a seawater treatment installation intended to be placed onboard an offshore platform or construction for the use of a seawater treatment method according to the invention for the production of undersea oil drilling injection water depleted in oxygen initially dissolved in said seawater.

Such an installation comprises according to the invention at least one battery incorporating a plurality of membrane modules assembled in series, said battery having an inlet connected to a water supply to be treated and an outlet connected to a treated water evacuation, each of said membrane modules housing at least one porous and hydrophobic membrane and having a scavenging gas inlet connection and an evacuation connection of said scavenging gas enriched with said initially dissolved gases, said at least one membrane enabling the passage of the oxygen from the water to the side of the membrane where the gases are circulating.

As described above, the porous and hydrophobic membranes used in the membrane modules may be organic membranes or mineral membranes rendered hydrophobic by a specific treatment known in the prior art.

Such an installation makes it possible to use a treatment method according to the invention and produce water significantly depleted in dissolved oxygen accordingly.

Preferentially, said battery incorporates 3 to 5 membrane modules assembled in series.

In this case, said battery advantageously incorporates 4 membrane modules assembled in series.

This number of modules enables effective seawater treatment.

According to a preferred characteristic, an installation according to the invention comprises injection means of least one reducing agent between two modules among at least one pair of consecutive modules in order to inject, in the water to be treated, an oxygen-reducing chemical agent which helps improve the lowering of the oxygen dissolved in the water.

In the embodiment wherein each battery incorporates four modules, said injection means are advantageously placed between the second and the third membrane module or between the third and the fourth membrane module of said battery.

Preferentially, said membranes are hollow-fibre membranes.

Said membranes favour the mixture of the reducing agent in water.

According to another advantageous characteristic, said modules house at least one diversion member which essentially extends perpendicularly to the axis of said membranes.

In this case, the membrane contactors behave like static mixers. They favour the mixing of the reducing agent and water and consequently help reduce the contact time required for the oxygen-reducing chemical agent to be able to act.

A type of membrane that may preferentially be used is described in the patent document bearing the number U.S. Pat. No. 5,352,361.

According to a preferred embodiment, a treatment installation according to the invention comprises a plurality of batteries assembled in parallel, a treated water evacuation manifold, a supply manifold of water to be treated, said inlet of each of said batteries being connected to said supply manifold and said outlet of each of said batteries being connected to said evacuation manifold.

The distribution of the membrane modules into several batteries in parallel makes it possible to divide the flow of water to be treated so as not to exceed the maximum permissible flow rate by each membrane module.

This architecture may also make it possible to multiply the treatment capacities of such an installation.

### LIST OF FIGURES

Other characteristics and advantages of the invention will emerge more clearly on reading the following description of a preferential embodiment, given as an illustrative and non-limitative example, and the appended figures, wherein:

FIG. 1 gives a schematic view of an example of installation for the use of the treatment method according to the invention;

FIG. 2 illustrates a sectional view of a membrane used in a contactor of the installation illustrated in FIG. 1;

FIG. 3 illustrates various positions of an installation for the use of the method according to the invention in various treatment installations.

### DESCRIPTION OF ONE EMBODIMENT OF THE INVENTION

### Summary of Principle of the Invention

The general principle of the invention is based on the use, in onboard seawater treatment installation on offshore platforms or constructions, of at least one battery of hydrophobic membrane contactors assembled in series and in which seawater and a scavenging gas having an oxygen content less than or equal to 5% molar circulate independently and at counter-current, in order to produce undersea oil drilling injection water wherein the dissolved oxygen content is less than 30 ppb and preferentially less than 10 ppb.

### Example of Installation for Implementing the Water Treatment Method According to the Invention

With reference to FIG. 1, an embodiment of a seawater treatment installation intended to be used on an offshore platform in order to produce undersea drilling injection water according to the treatment method according to the invention is shown.

As represented schematically in FIG. 1, such an installation comprises a frame 10 whereon three batteries B1, B2, B3 of membrane modules 11 are attached. The three batteries B1, B2, B3 are assembled in parallel. Each of these batteries B1, B2, B3 incorporates three membrane modules 11 which are assembled in series. These membrane modules 11 take the form of hydrophobic membrane contractors.

This original architecture offers numerous advantages in that it gives the installations for implementing the method according to the invention great flexibility and modularity.

The number of batteries, and the number of membrane modules used in each battery may in fact vary so as to obtain the required dissolved gas concentration thresholds and according to the quality of the seawater to be treated (temperature, dissolved gas concentrations, etc.).

Moreover, the distribution of the membrane modules 11 into several batteries in parallel makes it possible to subdivide the flow of water to be treated so as not to exceed the maximum permissible flow rate by each membrane module.

Also, the number of membrane modules 11 used in a battery may be increased easily so as to increase the dissolved gas elimination efficiency. In this way, it is understood that the greater the number of contactors used, the lower the dissolved oxygen content of the treated water obtained may be.

In addition, the membrane modules 11 may be arranged in all spatial directions, by being placed in parallel either on the same horizontal line, or on the same vertical line, or by being distributed into several horizontal lines parallel with each other and at a distance from each other (as represented in FIG. 1).

In this embodiment, each battery incorporates three membrane modules. In alternative embodiments, each battery may comprise between three and five membrane modules. According to a preferred solution, the number of membrane modules incorporated in each battery will be equal to four.

As can be seen in this FIG. 1, injection means 17 of at least one oxygen-reducing chemical agent in the water to be treated are placed between the second and third membrane module 11 of each battery B1, B2, B3. These injection means 17 comprise an injection nozzle.

More generally, these injection means are provided between two modules among at least one pair of consecutive modules, the injection means possibly taking the form of a nozzle, a line, a T coupling or any other device.

It is thus noted that, if each battery incorporates four membrane modules 11, these injectors are placed either between the second and the third or between the third and the fourth membrane module 11 of each battery B1, B2, B3.

In another alternative embodiment, it may be envisaged for an injector to be provided between the second and the third module and for another injector to be provided between the third and the fourth module.

It is noted that the membrane modules 11 may be those marketed by Celgard-Membrana under the brand Liqui-Cel® and which are the subject of the US patent bearing the number U.S. Pat. No. 5,352,361.

Each membrane module 11 comprises an inlet 111 and an outlet 112 whereby the seawater enters and leaves the contactor, respectively.

The inlet 111 of the first contactor 11 of each battery forms the inlet of the battery in question. The inlet of each battery is connected to an inlet for example a supply pipe 12 of seawater to be treated via a supply manifold 121.

The outlet 112 of the last contactor 11 of each battery forms the outlet of the battery in question. The outlet of each battery is connected to an evacuation for example a deoxygenated seawater evacuation pipe 13 via a treated water evacuation manifold 131.

Naturally, if an installation according to the invention comprises a single battery, the use of the supply 121 and evacuation manifolds 131 is not required.

Each membrane contactor 11 also comprises a scavenging gas inlet connection 113 and an outlet connection 114 of the scavenging gas enriched with gas initially dissolved in the seawater.

The inlet connection 113 of each contactor 11 is connected to a scavenging gas injection network 14. The outlet connection 114 of each contactor 11 is connected to an evacuation network 15 of a mixture of scavenging gas and gas initially dissolved in the seawater to be treated.

The scavenging gas injection network 14 is in turn connected to a scavenging gas production network (not shown).

In this embodiment, the scavenging gas is nitrogen wherein the purity is preferentially greater than 95% molar and advantageously greater than 99.9% molar. This may be obtained by means of a dedicated unit, onboard on the offshore platform or construction, using an ambient air element separation method, such as the PSA (Pressure Swing Adsorption) or gas membrane separation type.

In an alternative of this embodiment, the scavenging gas may be a petroleum gas available on the offshore platform or construction and which preferentially consists of at least 50% molar of methane, various alkanes (ethane, propane, butane, etc.) along with other hydrocarbon gases, CO₂ and water vapour.

The evacuation network 15 is connected to means enabling the creation of a vacuum in the gas phase, which may for example comprise a vacuum pump 16, preferentially a liquid ring vacuum pump, the liquid ring being seawater simply pre-filtered or drinking water if available. In alternative embodiments, these vacuum creation means may for example comprise an ejector.

As described in the U.S. Pat. No. 5,352,361, this type of membrane module preferentially houses hollow fibre membranes which extend along an axis essentially parallel to the axis whereby the water to be treated circulates inside the membrane module. These membrane modules also house at least one flow diversion element which extends essentially perpendicularly to the membrane axis. The use of such flow diversion element(s) makes it possible to orient the seawater flow within the membrane module such that it circulates tangentially and transversally with respect to the fibres. The use of these diversion elements enables the creation of dynamic phenomena within the membrane module such that it behaves like a static mixer. In other words, the use of this type of membrane modules is particularly advantageous particularly due to the fact that it makes it possible to obtain a homogeneous mixture between the liquid to be treated and the reducing agent(s) liable to be injected therein and, in this way, a reduction in the contact time between the water and the oxygen-reducing chemical agent required for it to act.

As explained below, the injection of oxygen-reducing chemical agent in the water to be treated makes it possible to improve the deoxygenation thereof. The fact that the membrane module behaves like a static mixer also helps favour the deoxygenation of the seawater. All this helps to reduce the size of the installations, by preventing the addition of contact tanks thereto.

The contactors 11 house a plurality of membranes which may consist of hollow fibres inserted in parallel in a carter, plane membranes wound in coils or stacked in slices, or any other type of configuration enabling the creation of two separate compartments, one dedicated to the passage of the liquid and the other dedicate to the passage of the gas.

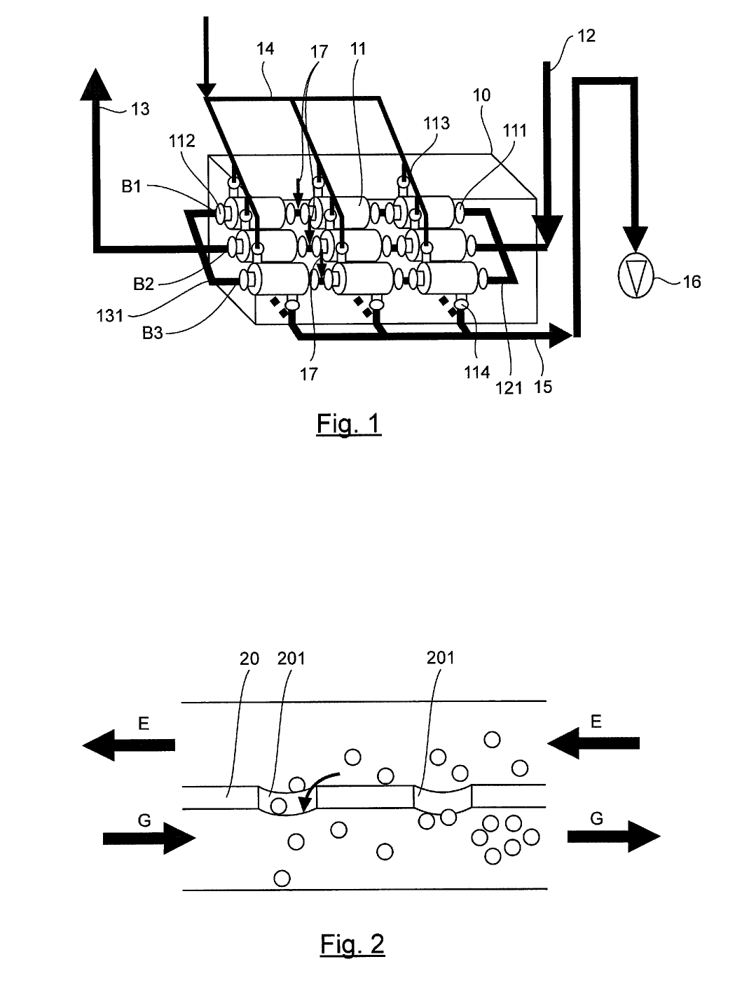

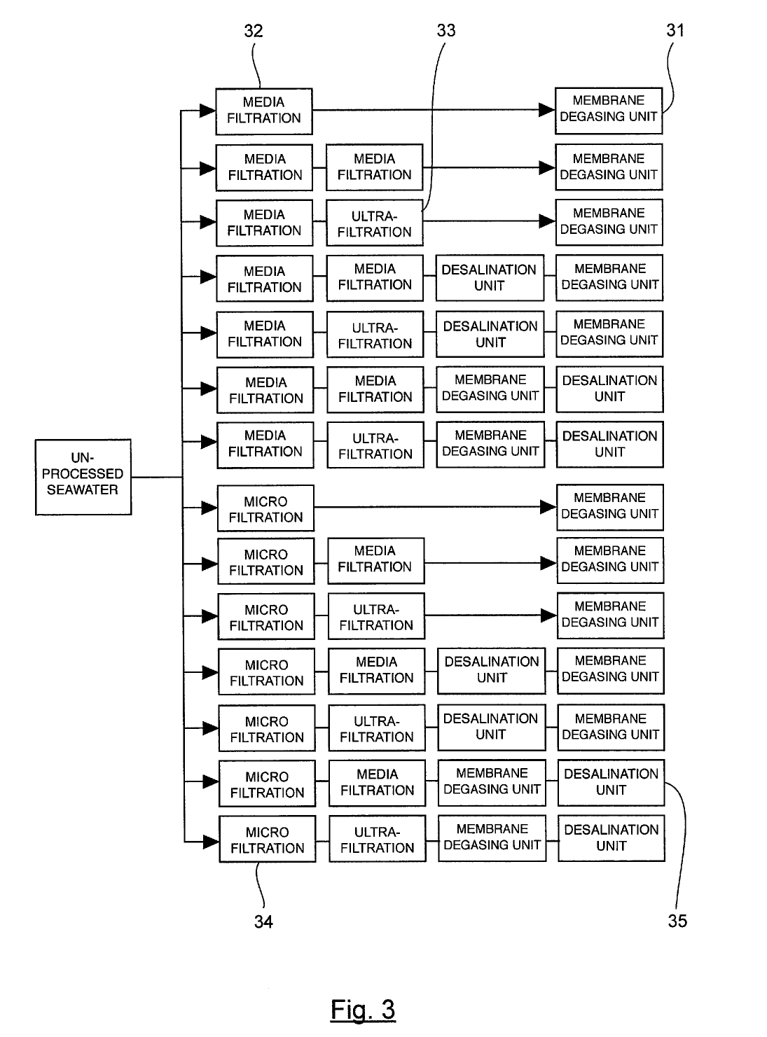

FIG. 2 illustrates schematically a sectional view of a hydrophobic membrane 20, displaying a plurality of pores 201, used in each of the membrane contactors 11. This membrane is made of a porous organic material (e.g. polypropylene, PVDF, etc.) and is hydrophobic, i.e. the pores 201 passing through same do not allow water to pass but only allow the gases to pass.

As illustrated in FIG. 3, an installation 31 for the use of a treatment method according to the invention may be preceded by media filtration installations 32, ultrafiltration installations 33 on membranes wherein the cutoff threshold is of the order of 10⁻² to 10⁻¹ μM, microfiltration installations 34 on membranes wherein the cutoff threshold is of the order of 10¹ to 1 μm. The term media filtration refers to any type of mechanical filtration comprising a granular or fibrous material and a material substrate, e.g. sand filter, two-layer filter, multimedia filter, diatomous filter, pre-layer filter charged with felt-based fibre, etc. An installation for the use of a method according to the invention may also be preceded and/or followed by selective desalination or deionisation installations 35 for example using reverse osmosis or nanofiltration.

A seawater treatment method for undersea drilling injection water production, according to the invention, is described below.

### Water Treatment Method According to the Invention

A seawater treatment method according to the invention may consist in passing the seawater to be treated into an installation such as that described above.

The seawater to be treated is injected via the supply pipe 12 and the supply manifold 121 into the first contactor 11 of each battery, while the scavenging gas, which in this case is nitrogen wherein the purity is preferentially greater than 95% and advantageously greater than 99.9% molar, is injected via the network 14 and the inlet connections 113 in each of the contactors 11.

It is noted that, in one alternative embodiment, the scavenging gas may be a petroleum gas available on the offshore platform and which preferentially consists of at least 50% molar of methane. The seawater (arrows E) and the scavenging gas (arrows G) circulate in this case in counter-current each on a different side of the hydrophobic membranes, independently in each of the contactors 11.

A petroleum gas contains a certain quantity of CO₂. For this reason, those skilled in the art consider the use thereof as a scavenging gas to be unsuitable. In fact, it is considered that there would be a risk of the CO₂ contained therein, or at the very least a part thereof, being transferred into the water during treatment, resulting in acidification of the water.

The Applicant demonstrated that a petroleum gas could be used as a scavenging gas, which offers a certain advantage. This gas, which is produced directly on the offshore installation during oil extraction, represents a directly available resource. The use of such a gas makes it possible to avoid generating nitrogen on the platform and therefore reducing the operating costs of the installation.

In parallel, the vacuum creation means are used such that the pressure at the scavenging gas end is lowered to a pressure less than 250 mmHg (i.e. approximately 33,320 Pa), and preferentially below 50 mm Hg.

The pressure at the liquid side being greater than that on the scavenging gas end, the gas/liquid interface is immobilised at the membrane pores.

The creation of a negative pressure in the gas phase and the use of a scavenging gas wherein the oxygen content is practically zero (oxygen content preferentially less than or equal to 5% molar) makes it possible to use a moving force which is in fact the combination of two moving forces to eliminate the oxygen dissolved in the seawater:
the lowering of the total pressure of the vapour phase by creating the vacuum;
the lowering of the partial oxygen pressure by depleting the oxygen content of the gas phase by replacing it by an oxygen-depleted gas, in this case, nitrogen with a purity of at least 95% and preferentially over 99.9% molar.

In this way, due to the low oxygen content of the scavenging gas and the low pressure thereof, the solubility of the dissolved oxygen, and that of other gases dissolved in the seawater, decreases such that the oxygen initially dissolved in the seawater passes via the pores of the hydrophobic membranes and mixes with the scavenging gas.

The reduction rate of the oxygen initially dissolved in the seawater may be reduced further. For this, it may be envisaged in an alternative embodiment for oxygen-reducing chemical agent injections in the seawater to be carried out. As already described, at least one injection is performed between two consecutive contactors.

In the installation described above, the injection of reducing agent is performed by activating the injectors 17 which are placed between the second and the third contactor 11 of each of the batteries. In one alternative embodiment wherein each battery incorporates four contactors 11, it is preferentially envisaged for these injectors to be positioned either between the second and the third contactors, or between the third and the fourth contactor.

The use of a media filtration step and/or a microfiltration step and/or an ultrafiltration step prior to the use of the seawater circulation and scavenging gas circulation steps may also be envisaged.

The use of a desalination step and/or deionisation step prior to or following the circulation steps may also be envisaged.

This may particularly make it possible to prevent the precipitation of salts and ions on membranes.

In another alternative embodiment, it may be envisaged to use a gas/liquid separation step at the outlet of the vacuum device in order to separate the water vapour condensates from the gas phase.

### Tests

An installation of the type described above, but comprising a single battery consisting of three and a half inch Liqui-Cel® membrane modules assembled in series was tested.

In a first test, the installation was used without injecting oxygen-reducing chemical agent.

An inlet seawater flow rate of 130 l/hr was used, said water also having a temperature of 15° C. and a salinity of 39 g/l.

99.9% molar pure nitrogen was used as the scavenging gas, at a pressure of 80 mm Hg (10664 Pa), and a flow rate of 0.1 Nm³/hr per membrane module.

The dissolved oxygen concentration of the seawater used in the installation was measured and found to be 8058 ppb.

The dissolved oxygen concentration of the seawater was also measured at the outlet of the first module, at the outlet of the second module and at the outlet of the third module.

At the outlet of the first module, the dissolved oxygen concentration of the water was 634 ppb. At the outlet of the second module, the dissolved oxygen concentration thereof was 82 ppb. Finally at the outlet of the third module, the dissolved oxygen concentration of the water was only 17 ppb.

In a second test, the injection of a reducing agent, i.e. sodium bisulphite (marketed under the name Hydrex®1320) between the second module and the third module of the installation, at a dose of 1 mg/l, was simulated using a suitable software program. This computer simulation made it possible to evaluate the dissolved oxygen content obtained if such an injection was actually used at less than 5 ppb.

### Advantage Offered by the Invention

The use of a seawater treatment method according to the invention offers numerous advantages compared to the techniques according to the prior art conventionally used in offshore platforms.

In particular, it makes it possible to produce, without injecting oxygen-reducing chemical agent, a treated water wherein the dissolved oxygen content is less than 30 ppb. Such a performance level cannot be achieved economically using the techniques according to the prior art without injecting oxygen-reducing chemical agent.

In addition, the technique makes it possible, with or without injecting oxygen-reducing chemical agent, to produce water wherein the dissolved oxygen content is less than 10 ppb. Such a performance level cannot be achieved using the techniques according to the prior art without injecting oxygen-reducing chemical agent.

It enables the production of injection water in accordance with the standards applied by oil producers while limiting the use of chemical products.

In addition, a method according to the invention displays great flexibility and modularity in that it can be used in installations wherein the capacities may easily change according to the variations in the flow rate of water to be treated, changes in water quality (temperature, dissolved gas concentration) by simply adding or removing contactors. This is particularly advantageous compared to the techniques according to the prior art. In fact, an increase in the capacities of vacuum degassing or stripping tower or a MINOX™ method requires the construction of a new unit in parallel.

The weight of an installation according to the invention is considerably lower than the weight of the installations according to the prior art particularly vacuum degassing or stripping towers which are heavy due to the quantity of water retained in the column volume in operation.

For example, the total loaded weight, comprising the water contained in the operating installation, estimated for a seawater deoxygenation treatment under with a capacity of 13,500 m³/hr is:
150 tonnes for a vacuum tower (or a stripping tower);
50 to 80 tonnes for an installation for the use of the MINOX™ method;
tonnes for an installation for the use of the method according to the invention.

The use of a method according to the invention thus enables a weight gain of least 40% and preferentially 60% with respect to the MINOX™ method, and 50% and potentially 90% with respect to a vacuum or stripping tower.

The specific surface area represents the exchange surface area between the gas and the liquid for a given volume. The specific surface area of an installation for the use of the method according to the invention may be greater than 5000 m²/m³, whereas that of a vacuum or stripping tower is generally between 50 and 500 m²/m³. The use of a method according to the invention thus enables to a user to obtain a gain in space with respect to a vacuum or stripping tower between 50 and 80%. Similarly, the gain in space obtained, compared to the use of a MINOX™ method, is between 5 and 30%.

1-19. (canceled)

20. A method for treating seawater and producing injection water for extracting oil from rocks, the method comprising:
directing the seawater having a relatively high oxygen concentration into a membrane module separated into first and second sections by a hydrophobic membrane, such that the seawater flows through the first section of the membrane module;
directing a scavenging gas having a relatively low oxygen concentration into the second section of the membrane module;
decreasing the pressure in the second section of the membrane module relative to the pressure in the first section of the membrane module;
reducing the oxygen concentration of the seawater by inducing the oxygen to flow from the seawater through the hydrophobic membrane and into the second section of the membrane module to mix with the scavenging gas; and
wherein the seawater having the reduced concentration of oxygen forms injection water used to extract oil from rocks.

21. The method of claim 20 wherein the scavenging gas is directed into the membrane module such that the gas flows in a counter-current direction relative to the seawater.

22. The method of claim 20 further comprising contacting the seawater with the hydrophobic membrane for a time period of between approximately 1 and approximately 5 seconds.

23. The method of claim 20 further comprising filtering the seawater before directing the seawater into the membrane module.

24. The method of claim 20 further comprising desalinating and deionizing the seawater before directing the seawater into the membrane module.

25. The method of claim 20 wherein a plurality of membrane modules are each separated into first and second sections by at least one of a plurality of hydrophobic membranes, and the method further comprises:
separating the seawater into a plurality of water flows;
directing each water flow into the first section of one of the membrane modules;
separating the scavenging gas into a plurality of gas flows;
directing each scavenging gas flow into the second section of one of the membrane modules;
decreasing the pressure in each second section relative to the pressure in each first section; and
reducing the oxygen concentration in each water flow by inducing the oxygen to flow from each water flow through one of the hydrophobic membranes and into one of the second sections to mix with one of the gas flows.

26. The method of claim 20 further comprising injecting an oxygen-reducing agent into the seawater.

27. The method of claim 25 further comprising:
directing each scavenging gas flow into one of the membrane modules in a counter-current direction relative to the water flow in that membrane module;
injecting an oxygen-reducing agent into the each water flow between two consecutive membrane modules;
contacting each water flow with one of the hydrophobic membranes for a time period of between approximately 1 and approximately 5 seconds; and
decreasing the pressure of each second section thereby causing the oxygen concentration in each water flow to decrease to less than 30 ppb.

28. The method of claim 25 further comprising:
directing the seawater into a supply water manifold and then separating the seawater into the plurality of water flows;
directing each water flow from the supply water manifold to the first section of one of the membrane modules;
directing the scavenging gas into a supply gas manifold and then separating the gas into the plurality of gas flows;
directing each gas flow from the supply gas manifold to the second section of one of the membrane modules;
decreasing the pressure of each second section with a vacuum pump thereby decreasing the oxygen concentration in each water flow;
directing each water flow from one of the membrane modules to a treated water manifold; and
directing each gas flow from one membrane module to an outlet gas manifold.

29. The method of claim 20 including maintaining the oxygen content of the scavenging gas at 5% molar or less.

30. The method of claim 20 including reducing the oxygen content of the seawater to 20 ppb or less.

31. The method of claim 20 including separating the seawater being treated from the scavenging gas with the hydrophobic membrane such that the seawater is not contacted by the scavenging gas.

32. The method of claim 20 wherein the method of treating the seawater is conducted in part at least on an offshore platform.

33. The method of claim 20 including redirecting the flow of seawater within the first section of the membrane module with a flow diversion element contained within the first section of the membrane module, and causing the seawater to circulate generally tangentially and transversely with respect to fibers of the hydrophobic membrane.

34. The method of claim 20 including utilizing nitrogen as the scavenging gas and wherein the purity of the nitrogen is greater than or equal to 95%.

35. The method of claim 34 including producing the nitrogen on an offshore platform or other structure.

36. The method of claim 20 including utilizing a petroleum gas as the scavenging gas and wherein the petroleum gas contains at least 5% molar of methane.

37. The method of claim 20 including maintaining the pressure of the scavenging gas between approximately 20 mm Hg and approximately 250 mm Hg.

38. A system for treating seawater and producing injection water for extracting oil from rocks, the system comprising:
a plurality of membrane modules, each membrane module separated into a first and second portion by a hydrophobic membrane;
a seawater supply inlet operatively connected to the plurality of membrane modules for directing seawater having a relatively high oxygen concentration to the first portion of one of the membrane modules;
a treated water outlet operatively connected to the membrane modules for directing treated water from the membrane modules;
a scavenging gas supply inlet operatively connected to the membrane modules for directing scavenging gas having a relatively low oxygen concentration to the second portion of one of the membrane modules; and
a scavenging gas outlet operatively connected to the membrane modules for directing scavenging gas from the membrane modules.

39. The system of claim 38 wherein the hydrophobic membrane is an organic membrane.

40. The system of claim 38 wherein the hydrophobic membrane is a mineral membrane.

41. The system of claim 38 wherein the hydrophobic membrane is a hollow fiber membrane.

42. The system of claim 38 further comprising an oxygen-reducing agent injection inlet that directs an oxygen-reducing agent into the seawater between two consecutive membranes modules.

43. The system of claim 38 further comprising:
a supply manifold operatively connected to the seawater supply inlet for directing seawater from the seawater supply inlet into the membrane modules;
a treated water manifold operatively connected to the treated water outlet for directing treated water from the membrane modules to the treated water outlet; and
a supply gas manifold operatively connected to the scavenging gas supply inlet for directing scavenging gas from the scavenging gas supply inlet to the membrane modules; and
an outlet gas manifold operatively connected to the scavenging gas outlet for directing scavenging gas from the membrane modules to the scavenging gas outlet.

44. The system of claim 38 wherein the pressure in the first section of each of the membrane modules is greater than the pressure in the second section of each of the membrane modules.

45. The system of claim 38 including means for maintaining the pressure of the scavenging gas between approximately 2666 Pa and approximately 33,320 Pa.

46. A system for treating seawater to produce injection water used to extract oil, the system comprising:
a membrane module;
a hydrophobic membrane extending across the membrane module and dividing the membrane module into first and second sections;
a seawater inlet for directing seawater into the first section of the membrane module;
a scavenging gas inlet operatively connected to the second section of the membrane module for directing a scavenging gas into the second section of the membrane module;
the seawater inlet and the scavenging gas inlet configured with respect to the membrane module to cause the seawater and scavenging gas to flow through the membrane module on opposite sides of the hydrophobic membrane in counter directions;
a pressure reducer operatively associated with the second section of the membrane module for reducing the pressure in the second section of the membrane module relative to the pressure in the first section of the membrane module; and
wherein the hydrophobic membrane generally prevents water from passing therethrough, but does permit oxygen contained in the seawater to pass from the seawater through the hydrophobic membrane and into the second section of the membrane module where the oxygen mixes with the scavenging gas.
